(19) United States
(12) Patent Application Publication
(10) Pub. No.: US 2008/0099105 A1
(43) Pub. Date: May 1, 2008

(54) Method for producing wood flooring

(76) Inventor: Timothy Kelly, Presque Isle, ME (US)

Correspondence Address: Kevin M. Farrell, Suite 350, One New Hampshire Avenue, Portsmouth, NH, 03801, US

(21) Appl. No.: 11/546,592

(22) Filed: Oct. 12, 2006

(51) Int. Cl. B27M 1/08; B27L 11/00; B27C 9/00; B27M 1/00

(52) U.S. Cl. 144/371; 144/373

(57) ABSTRACT

The present invention is directed to an improved method for producing wood flooring. This method comprises providing a roughhewn board having an upper and a lower surface and ripping the board to a desired width thereby providing a long length flooring blank. The method further includes scanning the long length flooring blank to maximize value and recovery and then cutting a dimensional flooring blank based on grade and length. The improved method also comprises automatically sorting the dimensional flooring blank based on grade and length, automatically orienting the dimensional flooring blank for downstream machining, and machining the oriented dimensional flooring blank to provide desired features.

### BACKGROUND

1. Field of the Invention

The present invention relates generally to the field of flooring manufacture and more particularly to automated flooring manufacturing processes having integrated automated scanners, automated cross cut saws, and automatic sorting and orienting means upstream of the machining process.

2. Discussion of Background information

Manufacturing processes for the production of solid hardwood flooring panels have existed since the late 1800s. These processes are generally operator-dependent, inefficient, and costly.

Flooring manufacture generally consists of preparing flooring blanks and then machining these blanks to create finished flooring pieces. Blank creation typically begins by ripping pieces of lumber to width and planing them to thickness. Operators then select blanks of consistent width and feed those blanks into an infeed of machining processes that output finished flooring pieces. These processes generally includes flattening the blanks, adding interlocking tongue and groove features, and optionally adding relief to the back face of the flooring. Operators then visually distinguish lumber grade along the top face of each blank and manually pull each piece through a chop saw to cut the long length pieces according to grade. This is a highly labor intensive process that relies on extensive training.

Automated laser scanners greatly improve this method by replacing operators both in identifying removable lumber defects and in identifying lumber grade. Optical laser scanners automatically detect defects such as knots, wane, cracks, blemishes, stains, and rot. Color cameras are capable of identifying subtle defects including differentiations between heartwood and sapwood. These automated scanners greatly improve accuracy and efficiency by eliminating subjective grade determination by an operator.

In addition to improving efficiency and reducing labor costs, scanners improve yield recovery. Present manufacturing processes rely on analyzing only one face of a blank, whereas a scanner can analyze multiple faces of a blank. Because of this ability, a scanner rapidly can identify pieces of higher value lumber that otherwise would be low grade or scrap based on an analysis of only a single face. The scanner can identify the defect in an otherwise usable piece of lumber and determine that cutting out that defect or sorting out a dimensionally scant piece would make that piece more valuable. Introducing these automated scanners into a flooring manufacturing line, therefore, increases the amount of valuable product identified, produced, and sold.

In addition to automated scanners, automated chop saws, or cross cut saws, also now exist. Automated scanners may feed lumber to such automated saws on an automated manufacturing line. Automated scanners output data usable by these automated chop saws, such as defect location or optimal cutting solution for a particular wood type. Chop saws then use this data to identify where to place cuts and how to sort the blanks after cutting. Following this sorting step, operators manually pile blanks onto storage pallets for later retrieval and manual delivery to the machining center.

Although automated scanners and automated saws improve process efficiency, operators still manually feed flooring blanks into the machining process. Additionally, placing the scanner downstream of the machining process limits recovery to use of just one face, the best face according to the upstream operator feeding the blanks into the machining center. A need exists for improved automation of flooring manufacturing lines and greatly improved recovery rates of valuable lumber that might otherwise be scrapped under current methods.

### SUMMARY OF THE INVENTION

The present invention is directed to an improved method for producing wood flooring that greatly increases value and recovery over existing methods. This method comprises providing a roughhewn board having an upper and a lower surface and ripping the board to a desired width thereby providing a long length flooring blank. The method further includes scanning the long length flooring blank to maximize value and recovery and then cutting a dimensional flooring blank based on grade and length. The improved method also comprises automatically sorting the dimensional flooring blank based on grade and length, automatically orienting the dimensional flooring blank for downstream machining by flipping and rolling the blank, and machining the oriented dimensional flooring blank to provide desired features.

### BRIEF DESCRIPTION OF THE DRAWINGS

These and other features, aspects, and advantages of the present invention will become better understood with reference to the following description, appended claims, and accompanying drawings where:

FIG. 1 shows a flow diagram of a historical method for producing wood flooring.

FIG. 2 shows a flow diagram of an automated method for producing wood flooring.

FIG. 3 shows a schematic diagram of a particular embodiment of a method for producing wood flooring according to the present invention.

### DETAILED DESCRIPTION

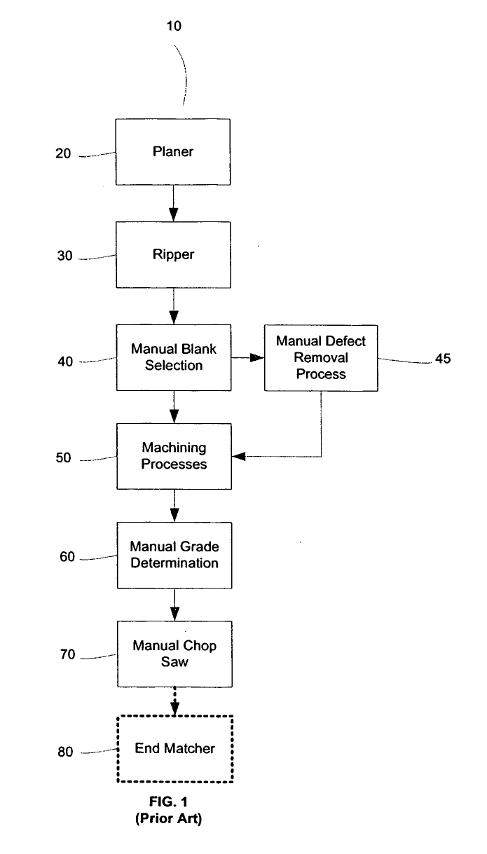

Referring now to FIG. 1, an historical method of wood flooring production 10 required a high dependence on manual labor for lumber processing and defect detection. Typically, a production line comprised a planer 20 and ripper 30 that operated in series to generate long length flooring blanks of consistent width and thickness. Operators at a manual blank selection 40 step identified blanks of consistent width and surveyed them for any gross defects that could cause problems during machining, defects such as knots, wane, crooks, and splinters. A manual defect removal process 45 existed for mitigating the deleterious effects of such defects, and operators at this process step sawed off any such-identified defective portion(s) of a flooring blank prior to the blank's entry into the machining processes 50.

Following the manual defect removal process 45, operators visually inspected each long length flooring blank to determine a best face before feeding each blank onto a conveyor feeding the machining processes 50. A “best” face was one that looked visually more appealing and manifested fewer imperfections than other faces. With the best face subjectively determined, an operator would feed the long length flooring blank into the infeed of the machining processes 50. These machining processes 50 typically included steps for molding the blank, flattening the blank, adding interlocking tongue and groove features, and adding relief to the back face of the flooring.

Once machined, the long length flooring piece traveled by lateral conveyor to a deck for a manual grade determination 60. At this step in the historical method of wood flooring production 10, operators retrieved each blank from the deck and determined lumber grade based again on a visual inspection of the best face. This visual determination resulted in a subjective determination of grade zones along the length of the blank's best face. With grade determined, operators at this stage pulled the long length pieces through a manual chop saw 70 to produce dimensional flooring blanks of appropriate grade and length. Lastly, operators manually delivered dimensional flooring blanks to an infeed of an end matcher 80. This highly labor intensive process relied on extensive training.

For several reasons, this historical method of wood flooring production 10 suffered from much inefficiency and potential profit loss. First, this method 10 allowed recovery of acceptable flooring from only one face of the long length blank because the machining processes 50 preceded the process step of manual grade determination 60. This historical method 10 failed to capture and recover any higher grade sections of that long length blank if lumber grade changed several times along a blank's length and if the best face alternated several times along the length. Once machined, a piece of lumber was permanently deformed. An operator at the entrance to the machining processes 50 subjectively determined a best face of each long length flooring blank, and operators further downstream made a manual grade determination 60 and subjectively chopped the blank according to apparent grade zones along the blank's length. No opportunities existed for maximizing value of a flooring blank prior to machining. Second, placing the manual chop saw 70 downstream of the machining center increased a need for manual labor and thereby precluded process optimization for cost recovery. Third, no recovery process existed for pieces of machined flooring that operators discarded for being too narrow or pieces that operators could have cut along their length for recovery and sale as a narrower and higher grade piece of flooring.

With the advent of automated lumber scanners and automated chop saws, wood flooring production lines improved. By incorporating these tools, manufacturers have overcome some of inefficiencies inherent in the historical method 10 by reducing labor costs and slightly increasing yield.

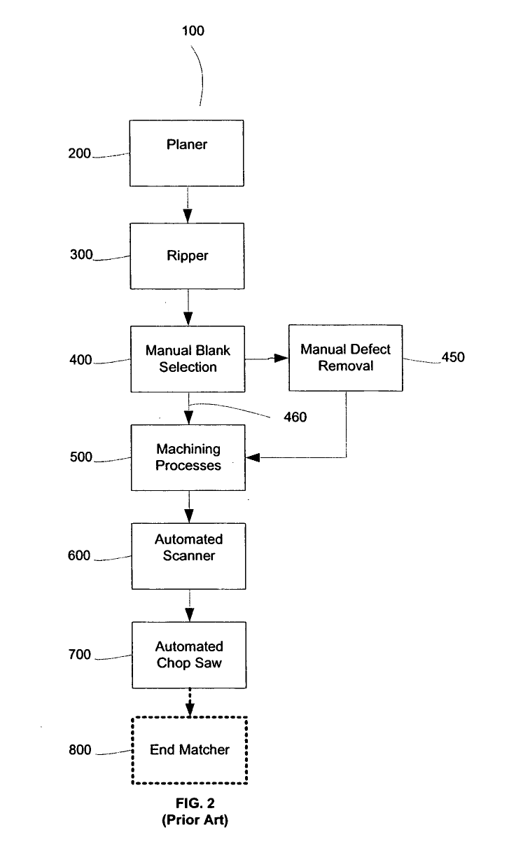

As shown in FIG. 2, an automated method of producing wood flooring 100 proceeds much like the historical method 10 of FIG. 1. A typical automated method 100 includes a planer 200 and a ripper 300 working in series to generate flooring blanks of consistent width and thickness. A manual blank selection 400 process step precedes manual defect removal 450, and operators then load long length flooring blanks onto an infeed to the machining processes 500.

This automated method of producing wood flooring 100 slightly improves upon the historical method 10 at the next stage in the manufacturing line, the automated scanner 600. Blanks leaving the machining processes 500 enter an automated scanner 600 that locates defects and distinguishes grade characteristics. Blanks then convey automatically or by manual transport to an automated chop saw 700 for removal of defects identified by the scanner. By identifying any markers or text printed on the flooring pieces and by interpreting positioning data provided by the scanner, the automated chop saw 700 accurately locates identified defects and grade zones and slices the flooring pieces accordingly to produce dimensional blanks.

Placing both an automated scanner 600 and an automated chop saw 700 downstream of the manufacturing processes 500 eliminates some labor costs by reducing the number of operators required for the manual grade determination 60 of the historical method 10 and final preparation with a manual chop saw 70. Production yields also slightly increase because of the accuracy with which the automated scanner 600 identifies defects. Inefficiencies, however, still exist. This automated method 100 fails to maximize yield or recovery because an operator still determines best face prior and because grade determination occurs after permanent deformation of the flooring blanks at the machining processes 500.

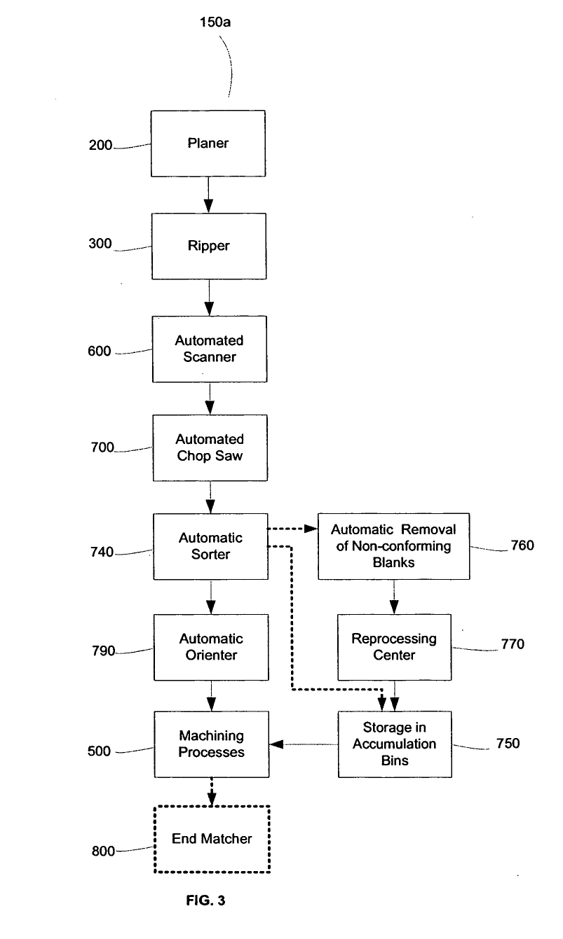

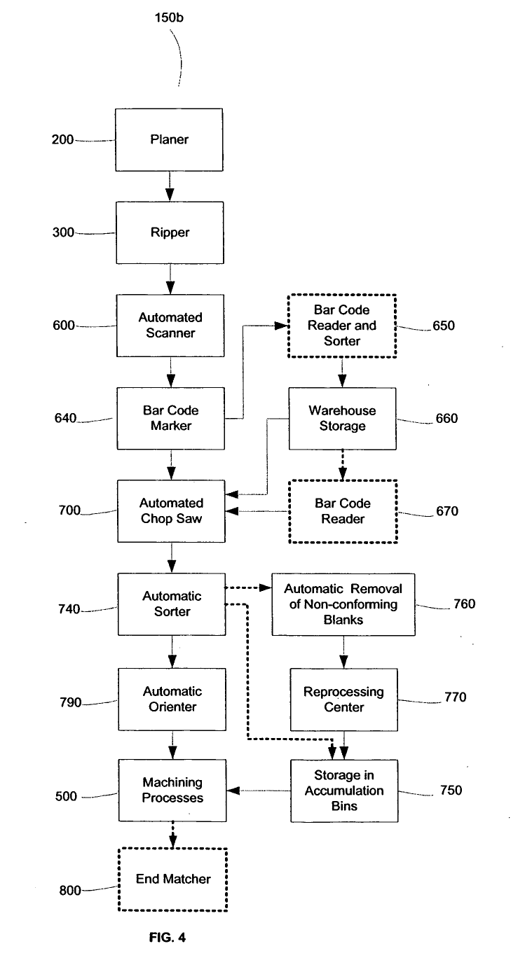

These deficiencies are addressed by the present invention. FIG. 3 depicts an embodiment of the invention, which is an improved method of manufacturing wood flooring 150a. This improved method 150a greatly improves upon the typical automated method of producing wood flooring 100. As with other methods already presented here, this improved method 150a optionally begins with a planer 200 and a ripper 300 that initially prepare long length flooring blanks for processing. These steps are optional because the automated scanner 600 and other automated equipment downstream are capable of inspecting raw lumber. The planer 200 and the ripper 300, therefore, may be omitted or placed further downstream.

In a preferred embodiment, however, the improved method 150a includes a planer 200 for planing raw, roughhewn lumber pieces on their top and bottom faces. This step provides a consistent thickness along each piece and cleans each surface for more accurate and efficient scanning. A ripper 300, or saw, then rips the planed lumber to produce long length flooring blanks of consistent width. In one embodiment, the ripper 300 optionally may incorporate a laser triangulation device that optimizes width recovery. Laser triangulation is well known technology in this art. Simple triangulating lasers “shape” the surface of a piece of lumber to deliver data on wane, taper and sweep to a PLC or computer. The processor then interfaces with a ripper 300 to optimize ripping the lumber to width. In another embodiment, the ripper 300 optionally may include overhead laser lights that assist with alignment for ripping lumber to pieces of consistent width. In this alternate embodiment, the overhead laser lights guide an operator who manually feeds and directs the lumber into the ripper 300.

Once a saw rips the lumber to width at the ripper 300 stage, the long length blanks convey to an infeed of an automated scanner 600 disposed upstream of the machining processes 500. Each blank conveys through the automated scanner 600 in a linear fashion. Automated scanners are also known in the art. Automated lumber scanners, like the WoodEye® Scanner made by Innovativ Vision, rapidly and accurately scan all surfaces of a blank and locate defects like black knots, wane, cracks, pith and stain. In addition to finding subtle defects through color matching techniques, these scanners are capable of differentiating between wood grades and types. For example, automated scanners are sophisticated enough to distinguish between heartwood and sapwood by analyzing the amount of red color in the wood. Scanners also may integrate lasers and black and white multi-sensor cameras to locate defects and analyze density differences and changes in fiber orientation.

In a preferred embodiment, the automated scanner 600 determines an appropriate cutting solution for a particular blank and forwards that solution from a reservoir to an automated chop saw 700. The scanner 600 collects and provides data on cut positions to the automated chop saw 700, or crosscut saw. The automated scanner 600 additionally may mark each blank to indicate orientation for later processing and output electronic processing instructions for cutting and sorting.

Scanners can simultaneously analyze multiple faces of a long length flooring blank. The best face of a blank may alternate several times along its length. By analyzing all surfaces of the blank, the automated scanner 600 identifies these changes and collects data on their locations. Data from the scanner presently relays through an intervening processor. Conceivably, software developments may enable integration of the automated scanner 600 and automated chop saw 700 so that the two machines talk directly and so that no solution transfer occurs. Presently, the automated chop saw 700 receives a blank and cutting solution from the automated scanner 600 and cuts the long length blank in accordance with the provided data. Later processes sort and orient the separated portions of the blank also according to data accumulated, analyzed and produced by the automated scanner 600.

Upon exiting the automated scanner 600, the long length flooring blank conveys to an infeed of an automated chop saw 700 along with any necessary cutting solution and electronic data transferred by the automated scanner 600. The automated chop saw 700 cuts the long length flooring blanks into dimensional blanks based on the positioning data provided by the automated scanner 600. That positioning data indicates where best to sever the long length blank to produce highest yield and highest quality dimensional flooring pieces. The automated chop saw 700 also may mark the dimensional blanks with ink dots and inkjet print for indicating best orientation of the blank when entering the machining processes 500.

The automated chop saw 700 integrates an automated sorter for parsing flooring blanks. The automated chop saw 700 might sever a long length blank into more than one dimensional flooring blank of different grades and sizes. This product variation necessitates sorting. Because the automated scanner 600 has already determined and delivered data on grade, an automated sorter 740 more easily can parse dimensional blanks into like batches. Depending on what product is running though to the end of the improved process 150a at a given time, some batches optionally may convey to the storage accumulation bins 750 to await later use and reintroduction into the automated line. The automated sorter 740 may be semi-automated and may require operator intervention to actuate and control any operator-dependent equipment or to manually convey dimensional flooring blanks to the storage accumulation bins 750.

The automatic sorter 740 also may employ a kicker to kick off boards that are smaller than a minimum dimension required by some or all of the machining processes 500. This improved method, therefore, includes a step for the automatic removal of non-conforming blanks 760. These non-conforming blanks convey to a reprocessing center 770 where they are further processed and recovered for use as alternate product. These reprocessed blanks also may convey to the storage accumulation bins 750 to await reintroduction into the improved process 150a production line.

Dimensional blanks leaving the automatic sorter 740 and traveling through remaining production processes then enter an automatic orienter 790. The automatic orienter 790 positions each dimensional flooring blank for entry into the machining processes 500 in accordance with any marks or data provided by the automated scanner 600 and automated chop saw 700. The automatic orienter 790 may employ automated or semi-automated means for flipping and rolling each blank. Preferably, the automatic orientor employs a flipper device for flipping or spinning a blank around its longitudinal axis. The automatic orienter 790 may also employ a device for rolling a flooring blank, reorienting it from end to end. For example, such a device may comprise a kicker that ejects the flooring blank into a sluice which then repositions the blank so that a particularly identified end now faces the entrance to the machining processes 500. These methods and devices may be fully automatic or may require operator intervention to actuate and control any operator-dependent equipment.

Once oriented, dimensional flooring blanks convey automatically, semi-automatically or manually to an infeed of the machining processes 500. The machining processes 500 apply desired features such as molding, applying relief, adding interlocking tongue and groove features, etc. Upon exiting the machining processes 500, flooring blanks then optionally feed into an end matcher 800, conveying via automatic or semi-automatic means.

In an alternate embodiment depicted in FIG. 4, an improved method for producing wood flooring 150b includes a bar code marker 640 disposed between the automated scanner 600 and automated chop saw 700. Alternatively, the automated scanner 600 may include therein a bar code marker 640. In either case, a bar code prints directly onto a scanned long length flooring blank. The bar code may be of any type, but preferably is a matrix type bar code, such as a 2D scatter bar code, that contains a large amount of usable data. A bar code may contain data pertaining to, for example, defect type and location, blank dimensions, blank grade and best orientation. The automated scanner 600 also may produce a cut list linked to the bar codes and containing data pertaining to all identified defects. Each cut list contains quality data and dimensional data for each blank, and that information stores to an electronic database that is searchable for selecting particular blanks and then processing those retrieved blanks. The bar code matrices and associated cut lists, therefore, provide an accurate and efficient way to store, retrieve and process scanned flooring blanks.

Once marked with a bar code, the long length flooring blank conveys to an automated chop saw 700 that may contain a bar code reader head for interpreting the data contained in the printed bar code. In another embodiment, scanned and marked long length flooring blanks may convey to an independent bar code reader and sorter 650 that batches blanks into like groups for delivery to a warehouse storage area 660. In yet another embodiment, the bar coded blanks relocate to a warehouse area without a bar code reader and sorter 650 therebetween for batching blanks of like quality. In this alternative embodiment, boards of varying quality will leave storage and enter an automated chop saw 700 that incorporates a bar code reader head for expeditiously processing bar code information. Alternatively, an independent bar code reader 670 may be disposed between the warehouse storage area 660 and the automated chop saw 700. FIG. 4 depicts placement of optional, independent bar code reader and sorter 650 and optional independent bar code reader 670 using dotted lines.

Overall, the improved method for producing wood flooring 150a, 150b is more efficient and more cost effective than the historical and automated methods 10, 100. The improved method 150a, 150b combines an upstream, automated scanner 600, an automated chop saw 700, an automated sorter 740 and an automated orienter 790 which results in higher production yields and higher recovery of flooring pieces that might otherwise be scrap material. The upstream placement of the automated scanner 600 is seemingly counterintuitive because the scanner no longer replaces manual laborers downstream of the machining process. The automated sorter 740 and automated orienter 790, however, help compensate for this by also reducing downstream labor requirements and by greatly improving yield and efficiency. The improved method of producing wood flooring 150a, 150b is, therefore, more efficient and most cost effective than other processes 10, 100.

The significant benefits of early placement of the automated scanner 600 combined with automated advancements in sorting and orienting are quantifiable. Traditional floor mills using the historical method for producing wood flooring 10 will recover as finished flooring product approximately 48-51% of purchased raw material. This percentage range covers a broad input grade mix. Employing the present improved method for producing wood flooring 150a, 150b and using an input grade mix lower than that traditionally used in the wood flooring industry results in a much larger recovery of 62-67% of raw material as finished flooring product.

In the historic method 10 and the automated method of flooring production 100, an operator feeding the machining processes 50, 500 made a visual inspection to determine a long length blank's best face. This method was tedious, highly inefficient and resulted in accepting the best average face of the blank. In other words, even if an opposite face was superior to the best face over a portion of a blank's length, that portion was lost because an operator already had determined a best overall face. The historic and automated methods 10, 100 provided no mechanism for recovering such portions having a better face on an opposite surface of the blank, that entire surface subjectively having been deemed to be a lesser-valued face.

Unlike prior methods of wood flooring production, the present improved method 150a, 150b produces graded, dimensional flooring blanks from the long length blanks prior to the machining process 500. This enables recovery of the better face, even if the better face changes for instance once, twice or three times over the length of a piece. An internal study of this improved method 150a, 150b revealed that the traditional automated method 100 discarded as scrap 10% of material processed through the machining processes 500 when, in fact, most of these pieces of scrapped material were acceptable as flooring on an opposite face. By employing the present improved method 150a, 150b grade recovery increased by 15% because the present invention turns the shorter flooring blanks prior to machining to identify more accurately a best face.

Placing the automated scanner 600 upstream in the manufacturing process also lowers labor costs. The down stream placement in the typical automated method 100 decreases labor costs slightly by replacing operators that would otherwise manually determine grade. By placing the automated scanner 600 upstream of the machining processes 500 the improved method 150a, 150b lowers costs by improving yield and additionally improving recovery of product that would otherwise constitute scrap. Because of efficiency and accuracy, this improved method 150a, 150b reduces cost of goods sold by at least 15-20%, a substantial improvement over existing, traditional wood flooring production methods.

Prior to machining, the improved method 150a, 150b segregates material that is better suited for an alternative product than the rest of its lot, that is dimensionally scant, or that would be of higher value with reprocessing. This improved method of producing wood flooring 150a, 150b recovers 25-30% of material that would otherwise be scrapped as opposed to the automated method 100, which recovers approximately only 4% by placing the scanner downstream of the machining processes 500.

It is noted that the foregoing examples have been provided merely for the purpose of explanation and are in no way to be construed as limiting of the present invention. While the present invention has been described with reference to an exemplary embodiment, it is understood that the words, which have been used herein, are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

I claim:

1. An improved method for producing wood flooring, the method comprising:
a) providing a roughhewn long length flooring blank having an upper and a lower surface;
b) scanning the long length flooring blank to maximize the value and recovery of the long length flooring blank;
c) cutting a dimensional flooring blank based on grade and length;
d) automatically sorting the dimensional flooring blank based on grade and length;
e) automatically orienting the dimensional flooring blank for downstream machining; and
f) machining the oriented dimensional flooring blank to provide desired features.

2. The method of claim 1, further comprising the step of ripping the long length flooring board to a desired width.

3. The method of claim 1, further comprising the step of planing the upper and lower surfaces to provide a uniform thickness.

4. The method of claim 1, wherein the scanning step further comprises determining a cutting solution for the cutting step and transferring this solution from the scanner to a cross cut saw.

5. The method of claim 1, wherein the scanning step further comprises marking the long length flooring blank with an indicator of orientation.

6. The method of claim 1, wherein the scanning step further comprises scanning all surfaces of the long length flooring board.

7. The method of claim 1, wherein the automatic sorting step further comprises removing any dimensional flooring blank that is shorter than a minimum length requirement of the machining step.

8. The method of claim 1, wherein the automatic orienting step further comprises flipping the dimensional flooring blank around its longitudinal axis.

9. The method of claim 1, wherein the automatic orienting step further comprises rolling the dimensional flooring blank from end to end.

10. The method of claim 1, wherein the automatic orienting step further comprises employing a kicker and a sluice for catching and reorienting the dimensional flooring blank.

11. An improved method for producing wood flooring, the method comprising:
a) providing a roughhewn board having an upper and a lower surface;
b) ripping the board to a desired width thereby providing a long length flooring blank;
c) scanning the long length flooring blank to maximize the value and recovery of the long length flooring blank;
d) marking the long length flooring blank with a bar code containing data on defects and quality;
e) cutting a dimensional flooring blank based on grade and length;
f) automatically sorting the dimensional flooring blank based on grade and length;
g) automatically orienting the dimensional flooring blank for downstream machining; and
h) machining the oriented dimensional flooring blank to provide desired features.

12. The method of claim 11, further comprising the step of planing the upper and lower surfaces to provide a uniform thickness.

13. The method of claim 11, wherein the scanning step further comprises determining a cutting solution for the cutting step and transferring this information from the scanner to a cross cut saw.

14. The method of claim 11, wherein the scanning step further comprises marking the board with an indicator of orientation.

15. The method of claim 11, wherein the scanning step further comprises scanning all surfaces of the long length flooring board.

16. The method of claim 11, wherein the automatic sorting step further comprises removing any dimensional flooring blank that is shorter than a minimum length requirement of the machining step.

17. The method of claim 11, wherein the automatic orienting step further comprises flipping the dimensional flooring blank around its longitudinal axis.

18. The method of claim 11, wherein the automatic orienting step further comprises rolling the dimensional flooring blank from end to end.

19. The method of claim 11, wherein the orienting step further comprises employing a kicker and a sluice for catching and reorienting the kicked dimensional flooring blank.

20. The method of claim 11, where in the machining step further employs an end matcher.

21. The method of claim 11, where in the marking step marks the long length flooring blank with a matrix bar code.
